(19) United States
(12) Patent Application Publication
(10) Pub. No.: US 2011/0056026 A1
(43) Pub. Date: Mar. 10, 2011

(54) Coaxial Cable Processing Tool

(76) Inventor: Pai-Wei Lin, Tu Cheng City (TW)

(21) Appl. No.: 12/721,682

(22) Filed: Mar. 11, 2010

(30) Foreign Application Priority Data
Sep. 10, 2009 (TW) 098216745

(51) Int. Cl. H01R 43/042; H02G 1/12; H01R 43/05

(52) U.S. Cl. 7/107; 30/90.1; 29/751

(57) ABSTRACT

A coaxial cable processing tool comprising a body, a rotary cutting module, and a crimping module are disclosed. The body comprises a first cable inlet hole. The rotary cutting module is mounted into the body, and it is used to substantially sever coaxial cables. The rotary cutting module comprises a movable rotary cutting unit, wherein the movable rotary cutting unit comprises a first opening, a first pressing section, and a first reacting portion. A first cutter is connected to the movable rotary cutting unit, and the first cutter can substantially sever coaxial cables. A first spring element is connected to the first reacting portion, and it is used to provide the first cutter with the cutting strength during rotary cutting; and a crimping module mounted onto the body is used to crimp coaxial cable with a coaxial terminal.

### BACKGROUND OF THE INVENTION

1. Field of the Invention

The present invention relates to a coaxial cable processing tool, and more particularly, to a tool which provides structural simplicity along with the functions of performing rotary cuts on a coaxial cable; crimping together a coaxial cable with a coaxial terminal; and allowing strip-cutting of the outer and inner insulators of a coaxial cable.

2. Description of the Related Art

Various hand tools for cutting coaxial cables exist in the prior art. Most of these tools consist of a two-bladed structure for snipping off a coaxial cable; however, these tools flatten the circular-shape of the coaxial cable and turn the cross-sectional surface of the processed area into an oval shape. Moreover, when the conducting center (a material such as steel) of the coaxial cable is harder than the blade, the two-bladed cutting method can cause the blade to crack, thus damaging the tool.

Furthermore, coaxial cable can be processed in different ways, such as cutting off the cable, stripping the insulator, and crimping a coaxial cable together with a coaxial terminal. In the prior art, every process has its own specialized hand tool, and it is not convenient to switch among these various tools.

Therefore, a coaxial cable processing tool is needed to address the aforementioned problems. The new coaxial cable processing tool must be multifunctional, small, and cheap in cost.

### SUMMARY OF THE INVENTION

The object of the present invention is to provide a coaxial cable processing tool which can be used to perform rotary cutting or crimping of the coaxial cable together with a coaxial terminal.

To achieve the above object, the present invention presents a coaxial cable processing tool comprising a body, a rotary cutting module, and a crimping module. The body comprises a first cable inlet hole. The rotary cutting module is mounted into the body, and it is used to substantially sever coaxial cables. The rotary cutting module comprises a movable rotary cutting unit, wherein the movable rotary cutting unit comprises a first opening, a first pressing section, and a first reacting portion. A first cutter is connected to the movable rotary cutting unit; the first cutter can substantially sever coaxial cables. A first spring element is connected to the first reacting portion, and it is used to provide the first cutter with the cutting strength during rotary cutting. A crimping module is mounted onto the body, and it is used to crimp coaxial cable with a coaxial terminal. Through the above configuration, the coaxial cable can be inserted into the space between the first cable inlet hole and the first opening when the first pressing section is pressed. When the first pressing section is released, the elastic force of the first spring will cause the coaxial cable to be clipped between the first cutter and the first cable inlet hole, and the first cutter can substantially cut off the coaxial cable by being rotated in an opposing rotational direction to the coaxial cable.

### BRIEF DESCRIPTION OF THE DRAWINGS

FIG. 1 is a disassembly diagram of a coaxial cable processing tool of the present invention.

FIG. 2 is a 3D diagram of a coaxial cable processing tool of the present invention.

FIG. 2A is a front view of a coaxial cable processing tool of the present invention.

FIG. 3 shows a diagram of a coaxial cable processing tool of the present invention rotary cutting a coaxial cable.

FIG. 4 shows the crimping between a coaxial cable and a coaxial terminal using a coaxial cable processing tool of the present invention.

FIG. 4A shows the coaxial cable and a coaxial terminal before the crimping process.

FIG. 4B shows the coaxial cable and a coaxial terminal after the crimping process.

FIG. 5 shows the stripping of coaxial cable using a coaxial cable processing tool of the present invention.

FIG. 5A shows the coaxial cable after it has been stripped.

### DETAILED DESCRIPTION OF THE PREFERRED EMBODIMENT

The advantages and innovative features of the invention will become more apparent from the following preferred embodiments.

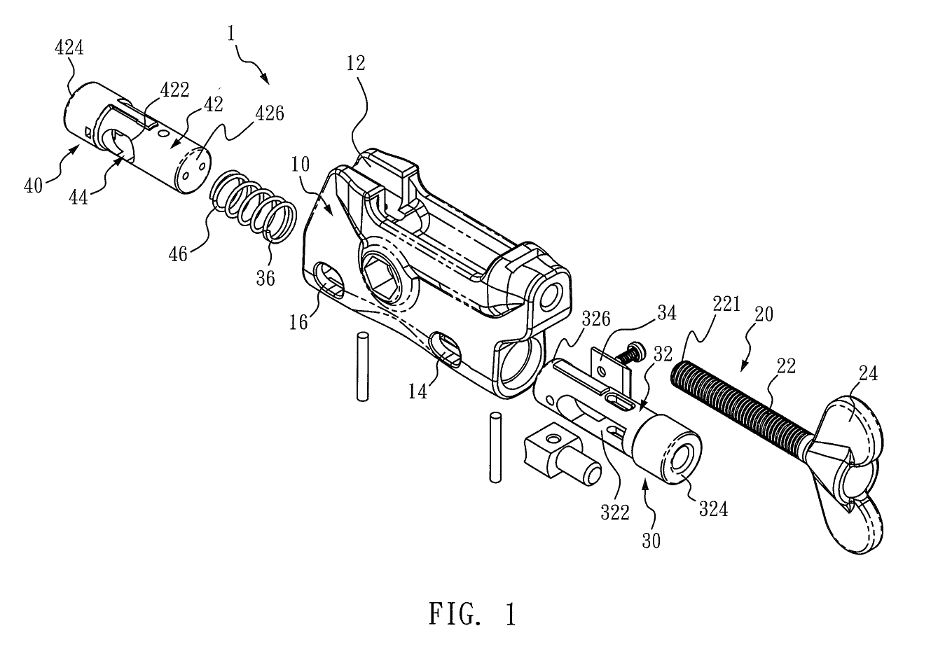

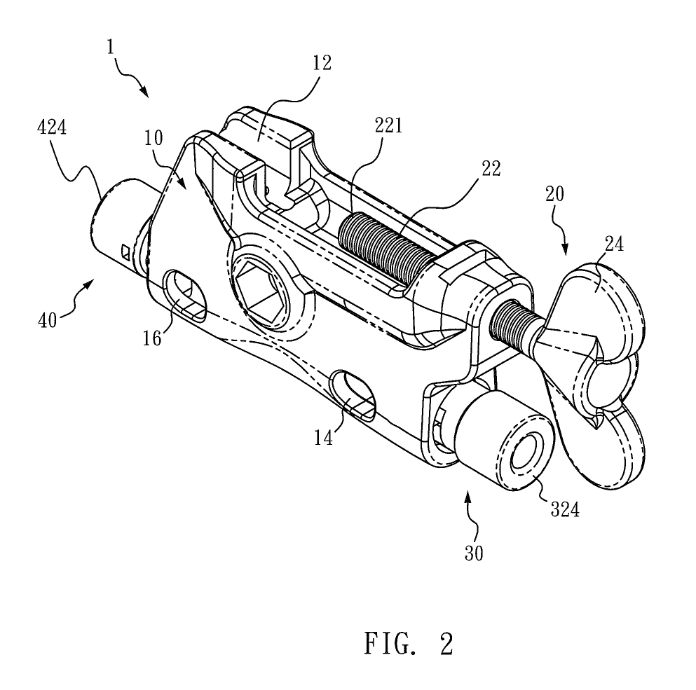

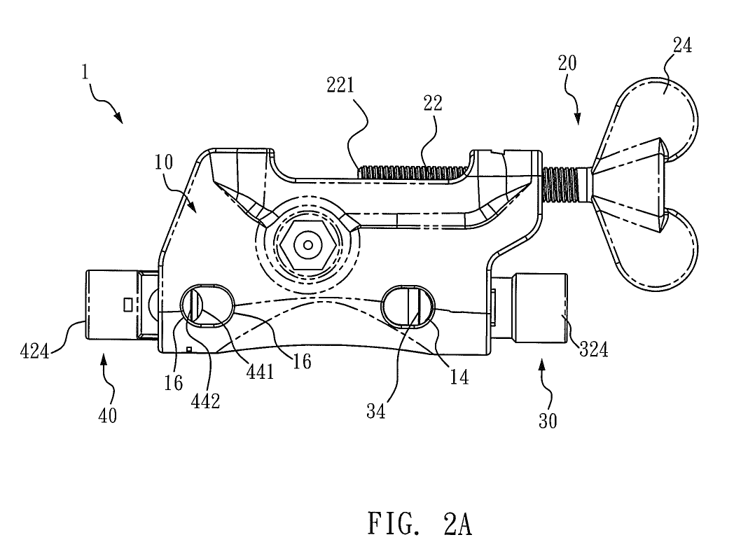

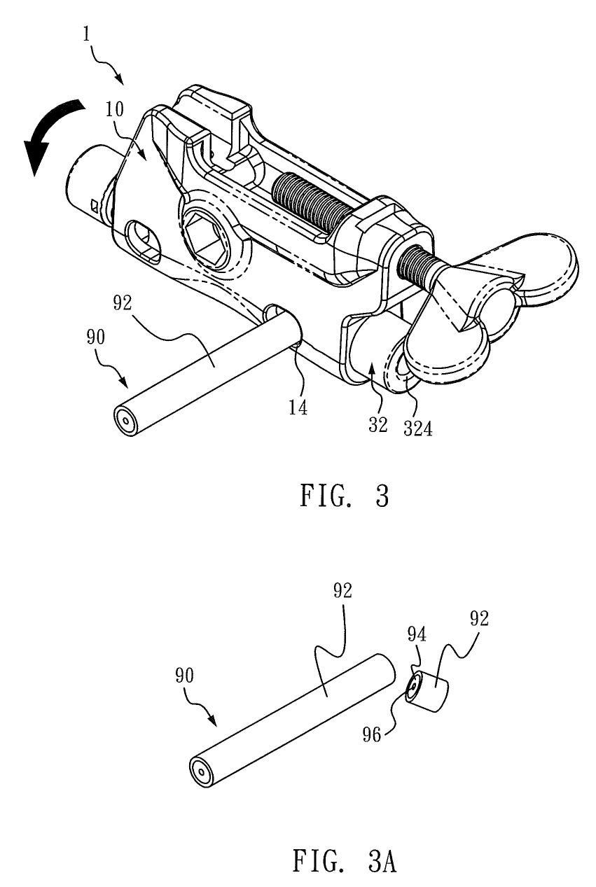

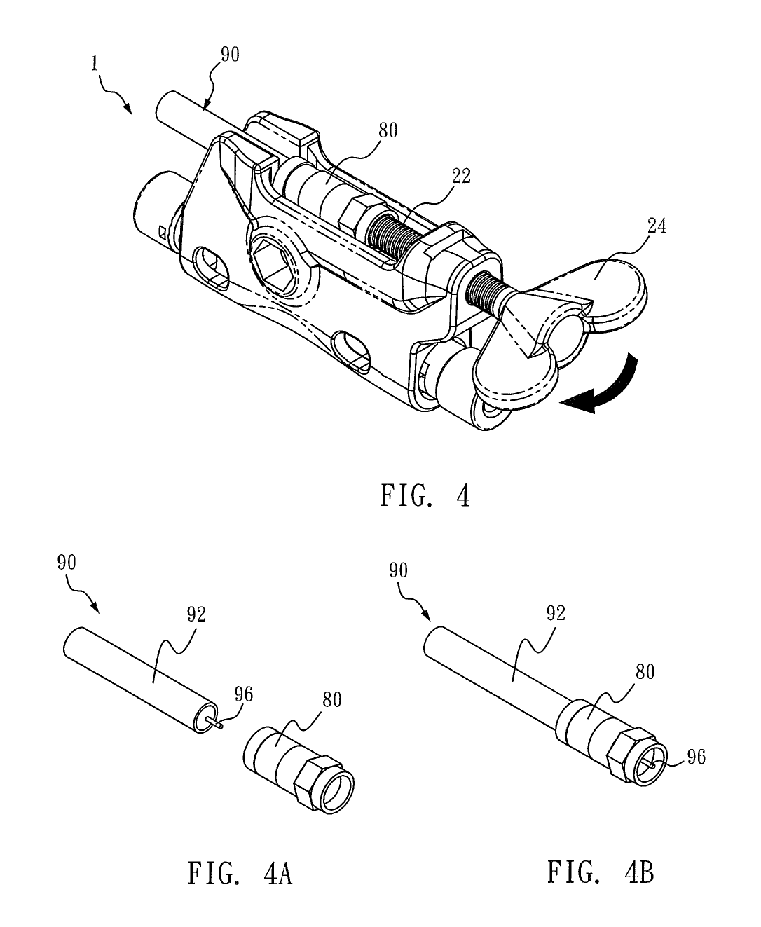

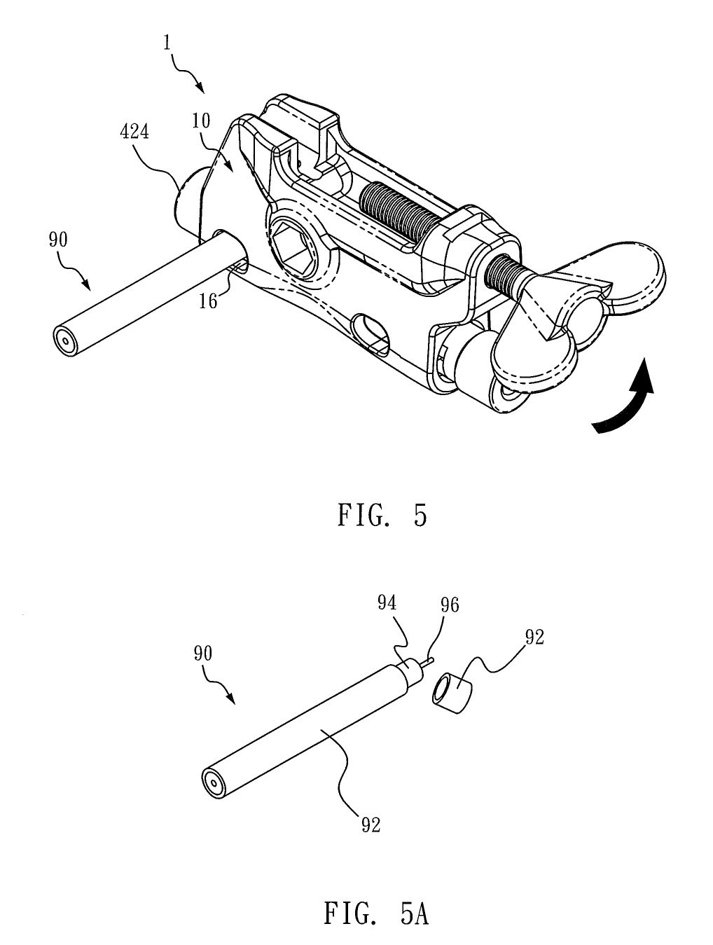

Refer to FIG. 1, FIG. 2 and FIG. 2A simultaneously. FIG. 1 is a disassembly diagram of a coaxial cable processing tool. FIG. 2 is a 3D diagram of a coaxial cable processing tool. FIG. 2A is a front view of a coaxial cable processing tool. The coaxial cable processing tool 1 of the present invention is used for processing coaxial cable 90, wherein coaxial cable 90 comprises an outer insulator 92, an inner insulator 94, and a conductor 96 (refer to FIG. 5). In the present embodiment, the coaxial cable processing tool 1 comprises three functions, including: rotary cutting the coaxial cable 90 (as shown in FIG. 3); crimping the coaxial cable 90 with a coaxial terminal 80 (as shown in FIG. 4A), and strip cutting the outer insulator 92 and inner insulator 94 (as shown in FIG. 5A). Take note that the coaxial cable processing tool 1 of the present invention does not necessarily include all the functionalities as mentioned above. For example, it can consist of only the functionality of crimping and rotary cutting of the coaxial cable 90.

The coaxial cable processing tool 1 comprises a body 10, a rotary cutting module 30, a crimping module 20, and a stripping module 40. These modules are mounted into the body 10. The body 10 comprises a cable placement groove 12, a first cable inlet hole 14, and a second cable inlet hole 16; the crimping module 20 can fit into the position of the cable placement groove 12; the position of the first cable inlet hole 14 corresponds with the rotary cutting module 30; the position of the second cable inlet hole 16 corresponds with the stripping module 40.

The following describes the structure and the function of the rotary cutting module 30. Refer to FIG. 1, FIG. 2, FIG. 2A, FIG. 3 and FIG. 3A simultaneously. FIG. 3 shows a diagram of a coaxial cable processing tool rotary cutting a coaxial cable.

The rotary cutting module 30 is used to substantially sever the coaxial cable 90. The rotary cutting module 30 comprises a movable rotary cutting unit 32, a first cutter 34, and a first spring 36.

The movable rotary cutting unit 32 comprises a first opening 322, a first pressing section 324, and a first reacting portion 326. The first opening 322 is used for inserting the coaxial cable 90, and the first pressing section 324 is to be pressed by the user. In the present embodiment, the first pressing section 324 protrudes from the body 10; the position of the first reacting portion 326 of the movable rotary cutting unit 32 is located on the opposite side of the first pressing section 324.

The first cutter 34 is connected with the movable rotary cutter 32; as a result, the first cutter 34 will move along with the movable rotary cutter 32. The first cutter 34 can substantially sever the coaxial cable 90.

The first spring 36 is pressed against the reacting portion 326; the first spring 36 provides the first cutter 34 with the force for performing rotary cutting. Refer to FIG. 2A. The coaxial cable 90 cannot be placed between the first cutter 34 and the first cable inlet hole 14 before the user presses the first pressing section 324. After the first pressing section 324 is pressed to act against the first spring 36, the space formed between the first cutter 34 and the first cable inlet hole 14 is enlarged.

Meanwhile, the coaxial cable 90 can be inserted between the space formed between the first cable inlet hole 14 and the first cutter 34. When the user releases the first pressing section 324, the elastic force of the spring 36 causes the coaxial cable 90 to be clipped between the first cutter 34 and the first cable inlet hole 14.

Next, the user can hold the coaxial cable processing tool 1 in one hand, and hold the coaxial cable 90 in the other hand and rotate the coaxial cable processing tool 1 (in an counterclockwise direction, as shown in FIG. 3; however, the body 10 can also be rotated in a clockwise direction, as long as the coaxial cable 90 remains in a stable position) such that the first cutter 34 cuts the outer perimeter of the coaxial cable 90 in a circular manner. Meanwhile, the first spring 36 is pressed against the first cutter 34, which causes the cut to deepen as the first cutter 34 rotates around the external perimeters of the coaxial cable 90 until the cable is completely severed by the first cutter 34 (as shown in FIG. 3A).

Theoretically the edge of the first cutter 34 will cut into the center of the coaxial cable 90 to sever the cable completely.

The following section describes the function and the structure of the crimping module 20. Refer to FIG. 1, FIG. 2, FIG. 2A, FIG. 4 and FIG. 4A. FIG. 4 shows the crimping between a coaxial cable and a coaxial terminal using a coaxial cable processing tool. FIG. 4A shows the coaxial cable and a coaxial terminal before the crimping process. FIG. 4B shows the coaxial cable and a coaxial terminal after the crimping process.

The crimping module 20 is used to crimp the coaxial cable 90 with the coaxial terminal 80. The crimping module 20 comprises a screw 22 and a handle section 24. The screw 22 comprises an ending section 221. The coaxial cable 90 and the coaxial terminal 80 are two separate pieces (as shown in FIG. 4A). When the user intends to crimp the coaxial cable 90 with the coaxial terminal 80, the coaxial cable 90 is first placed in the cable placement groove 12 such that the coaxial terminal is located between the coaxial cable 90 and the screw 22. When the handle section 24 is rotated (in a clockwise direction, as shown by the arrow in FIG. 4, but the handle section 24 needs to be rotated in a counterclockwise direction when the thread of the screw 22 is in a reversed direction), the screw 22 moves towards the coaxial terminal 80 such that the ending 221 of the screw 22 comes into contact with the coaxial terminal 80 and exerts pressure. The user then rotates the handle 24 continuously, and finally the coaxial cable 90 and the coaxial terminal 80 will be tightly crimped together (as shown in FIG. 4A).

The following section describes the function and the structure of the stripping module 40. Refer to FIG. 1, FIG. 2, FIG. 2A, FIG. 5 and FIG. 5A simultaneously. FIG. 5 shows the stripping of a coaxial cable using a coaxial cable processing tool. FIG. 5A shows the coaxial cable after it has been stripped.

The stripping module 40 is used to strip the coaxial cable 90. The stripping module 40 comprises a movable stripping unit 42, a second cutter 44, and a second spring 46.

The movable stripping unit 42 comprises a second opening 442 (as shown in FIG. 1), a second pressing section 424, and a second reacting portion 426. The second opening 442 allows the insertion of the coaxial cable 90; the second pressing section 424 protrudes from the body 10; the position of the second reacting portion 426 of the movable stripping unit 42 is located on the opposite side of the second pressing section 424. In the present embodiment, the movable rotary cutting unit 32 and the movable stripping unit 42 substantially move along the same axis, but in opposite directions.

The second cutter 44 is connected with the movable stripping unit 42; therefore, the second cutter 44 will move along with the movable stripping unit 42. The second cutter 44 can strip off the outer insulator 92 and/or the inner insulator 94 of the coaxial cable 90 (as shown in FIG. 5A).

The second cutter 44 comprises at least one blade. In order to remove the outer insulator 92 and the inner insulator 94, the second cutter 44 comprises a first blade 441 and a second blade 442 with a fixed spacing in between these two blades (as shown in FIG. 2), wherein the second blade 442 feeds in more than first blade 441, and wherein the feeding depth of the first blade 441 and the second blade 442 corresponds to the depth of the outer insulator 92 and the inner insulator 94 such that the first blade 441 cuts the outer insulator 92 and the second blade 442 cuts the inner insulator 94.

The second spring 46 is pressed against the second reacting portion 426; the second spring 46 provides the second cutter 44 with the stripping force during rotary cutting. In the present embodiment, the first spring 36 and the second spring 46 are formed in one piece such that the first reacting portion 326 and the second reacting portion 426 can be pressed against by a single spring.

Refer to FIG. 2A. The coaxial cable 90 cannot be inserted between the second blade 442 of the second cutter 44 and the second cable inlet hole 16 before the user presses the second pressing section 424. After the second pressing section 424 is pressed to compress the second spring 46, the space formed between the second blade 442 of the second cutter 44 and the second cable inlet hole 16 is enlarged.

Meanwhile, the coaxial cable 90 can be inserted between the space formed between the second cable inlet hole 16 and the second blade 442 of the second cutter 44. When the user releases the second pressing section 424, the elastic force of the spring 46 causes the coaxial cable 90 to be clipped between the second cutter 44 and the second cable inlet hole 16.

Next, the user can hold the coaxial cable processing tool 1 in one hand, hold the coaxial cable 90 in the other hand, and rotate the coaxial cable processing tool 1 (as shown in FIG. 5; a counterclockwise arrow indicates the rotational direction of the body 10; however, the body 10 can also be rotated in a clockwise direction, as long as the coaxial cable 90 remains in a fixed position) such that the second cutter 44 is able to cut the outer perimeter of the coaxial cable 90 in a circular manner. Meanwhile, the second spring 46 is pressed against the second cutter 44; as a result, the cut gets deeper as the second cutter 44 rotates around the external perimeter of the coaxial cable 90 until the first blade 441 of the second cutter 44 removes the outer insulator 92 and the second blade 442 of the second cutter 44 removes the inner insulator 94 of the coaxial cable 90 (as shown in FIG. 5A).

With the aforementioned details, the coaxial cable processing tool of the present invention is able to combine functionalities such as rotary cutting a coaxial cable 90, crimping a coaxial terminal 80 with a coaxial cable 90, and removing an outer insulator 92 and an inner insulator 94. The present invention is multifunctional and reduces the overall space occupied by the tools; therefore, the user needs not to purchase separate tools for each function, which makes coaxial cable processing more convenient while simultaneously reducing manufacturing and the purchasing costs.

Although the present invention has been explained in relation to its preferred embodiment, it is also of vital importance to acknowledge that many other possible modifications and variations can be made without departing from the spirit and scope of the invention as hereinafter claimed.

What is claimed is:

1. A coaxial cable processing tool for processing a coaxial cable or crimping together the coaxial cable with a coaxial terminal, wherein the coaxial cable consists of an outer insulator, an inner insulator, and a conductor, the coaxial cable processing tool comprising:
a body comprising a first cable inlet hole;
a rotary cutting module mounted into the body, and the rotary cutting module is used to cut off at least a portion of the coaxial cable, the rotary cutting module comprising:
a movable rotary cutting unit comprising a first opening, a first pressing section, and a first reacting portion;
a first cutter connected to the movable rotary cutting unit; the first cutter can cut off at least a portion of the coaxial cable; and
a first spring element connected to the first reacting portion, and the first spring is used to provide the first cutter with the cutting strength during rotary cutting; and
a crimping module mounted in the body, wherein the crimping module is used to crimp the coaxial cable with the coaxial terminal;
whereby the coaxial cable can be placed between the first cutter and the first cable inlet hole when the first pressing section is pressed; when the first pressing section is released, the elastic force of the spring causes the coaxial cable to be clipped between the first cutter and the first cable inlet hole, and the first cutter can cut off at least a portion of the coaxial cable by rotating the first cutter in an opposing rotational direction to the coaxial cable.

2. The coaxial cable processing tool as claimed in claim 1, wherein the body further comprises a cable placement groove, and the crimping module further comprises a screw and a handle section, wherein the screw comprises an ending section; when the coaxial cable is crimped with the coaxial terminal, the coaxial cable is placed in the cable placement groove such that the coaxial terminal is located between the coaxial cable and the screw; when the handle section is rotated, the screw then moves towards the coaxial terminal, and finally the coaxial cable and the coaxial terminal will be crimped together.

3. The coaxial cable processing tool as claimed in claim 1, wherein the body further comprises a second cable inlet hole, the coaxial cable processing tool further comprising:
a stripping module mounted into the body, wherein the stripping module is used to strip the coaxial cable, the stripping module comprising:
a movable stripping unit comprising a second opening, a second pressing section, and a second reacting portion;
a second cutter connected with the movable stripping unit, and the second cutter can strip the coaxial cable; and
a second spring connected with the second reacting portion, and the second spring provides the second cutter with the stripping force during rotary cutting;
whereby the coaxial cable can be placed between the second cutter and the second cable inlet hole when the second pressing section is pressed; when the second pressing section is released, the elastic force of the spring causes the coaxial cable to be clipped between the second cutter and the second cable inlet hole, and when the second cutter is rotated in an opposing rotational direction to the coaxial cable, the second cutter can strip off the outer insulator or the inner insulator of the coaxial cable.

4. The coaxial cable processing tool as claimed in claim 3, wherein the second cutter comprises at least one blade.

5. The coaxial cable processing tool as claimed in claim 3, wherein the second cutter comprises a first blade and a second blade; the first blade can strip the outer insulator, and the second blade can strip the inner insulator.

6. The coaxial cable processing tool as claimed in claim 3, wherein the movable rotary cutting unit and the movable stripping unit substantially move along the same axis.

7. The coaxial cable processing tool as claimed in claim 3, wherein the first spring and the second spring are made in one piece.

8. The coaxial cable processing tool as claimed in claim 3, wherein the first pressing section and the second pressing section protrude from the body.

9. The coaxial cable processing tool as claimed in claim 1, wherein the first cutter can substantially sever the coaxial cable.

10. The coaxial cable processing tool as claimed in claim 2, wherein the body further comprises a second cable inlet hole, the coaxial cable processing tool further comprising:
a stripping module mounted into the body, wherein the stripping module is used to strip the coaxial cable, the stripping module comprising:
a movable stripping unit comprising a second opening, a second pressing section, and a second reacting portion;
a second cutter connected with the movable stripping unit, and the second cutter can strip the coaxial cable; and
a second spring connected with the second reacting portion, and the second spring provides the second cutter with the stripping force during rotary cutting;
whereby the coaxial cable can be placed between the second cutter and the second cable inlet hole when the second pressing section is pressed; when the second pressing section is released, the elastic force of the spring causes the coaxial cable to be clipped between the second cutter and the second cable inlet hole, and when the second cutter is rotated in an opposing rotational direction to the coaxial cable, the second cutter can strip off the outer insulator or the inner insulator of the coaxial cable.

11. The coaxial cable processing tool as claimed in claim 10, wherein the second cutter comprises at least one blade.

12. The coaxial cable processing tool as claimed in claim 10, wherein the second cutter comprises a first blade and a second blade; the first blade can strip the outer insulator, and the second blade can strip the inner insulator.

13. The coaxial cable processing tool as claimed in claim 10, wherein the movable rotary cutting unit and the movable stripping unit substantially move along the same axis.

14. The coaxial cable processing tool as claimed in claim 10, wherein the first spring and the second spring are made in one piece.

15. The coaxial cable processing tool as claimed in claim 10, wherein the first pressing section and the second pressing section protrude from the body.
